(19) United States
(12) Patent Application Publication
(10) Pub. No.: US 2021/0299718 A1
(43) Pub. Date: Sep. 30, 2021

(54) Method for Producing a Composite Material

(71) Applicant: Wickeder Westfalenstahl GmbH, Wickede (DE)

(72) Inventors: Lutz HOFMANN, Wickede (DE); Andreas WELLIE, Essen (DE); Joseph Paul MENNUCCI, Lincoln, RI (US)

(21) Appl. No.: 17/347,123

(22) Filed: Jun. 14, 2021

Related U.S. Application Data
(63) Continuation of application No. PCT/EP2018/084996, filed on Dec. 14, 2018.

(51) Int. Cl. B21B 1/38; B23K 20/04; B23K 20/22

(52) U.S. Cl. CPC B21B 1/38; B23K 2103/18; B23K 20/22; B23K 20/04

(57) ABSTRACT

A method for producing a composite material includes: producing a first strip from a first material; producing a second strip from a second material; producing a third strip from a third material; arranging the first and second strips next to one another; connecting the first strip to the second strip in the state when arranged next to one another to form a first composite strip; arranging the first composite strip above or below the third strip; and connecting the first composite strip to the third strip.

### CROSS REFERENCE TO RELATED APPLICATIONS

This application is a continuation of International Application No. PCT/EP2018/084996, filed on Dec. 14, 2018, the entire contents of which are hereby incorporated by reference.

### TECHNICAL FIELD

The present invention relates to a method for producing a composite material.

### BACKGROUND

The process of cladding a first strip-shaped material with a second strip-shaped material is known from the prior art. It is also known to clad a wide strip with two narrow strips, wherein the narrow strips are arranged next to one another such that they cover the entire wide strip. Known cladding variants are referred to as inlay, corelay, side-to-side and edgelay, or similar. These variants all have the common factor that at least two narrow strips are arranged next to one another and at least one wider strip is cladded with these strips which are arranged next to one another.

However, in the case of strips which are arranged next to one another during the cladding operation, there is the risk that contaminants and/or lubricants pass into the join between the strips during the cladding operation or prior to the cladding operation. The surfaces of the strips also require complex pretreatment. It may also be the case that the two narrow strips do not form a closed strip surface after the cladding operation. This may be a problem for further processing steps.

Known methods are disclosed, for example, in DE 10 258 824 B3 and WO 2016/160049 A1.

### SUMMARY

By contrast, the present invention is based on the object of providing a method that is less prone to error and that can be used to produce high-quality composite materials. The intention is also to provide an apparatus which is suitable for carrying out such a method.

A first strip is produced from a first material, a second strip is produced from a second material, and a third strip is produced. The third strip may be produced from the first material or from a third material. Here, in the context of this description, a strip is understood to mean a geometry which has a small thickness, an average width and a large length. For example, the width may amount to several times, in particular more than five times, the thickness. The length may for example amount to more than ten times the width.

The first and second strips are arranged next to one another and, in this state, are connected to one another to form a first composite strip. In this case, the connection is effected along the longitudinal direction of the strips. The width of the composite strip amounts to the sum total of the widths of the first and second strips. It is of course also possible for the first composite strip to also comprise further strips, which may be composed of the first or the second material or another material. In the context of this description, a composite strip is understood to mean in particular a strip which has been produced from different strips made of different materials.

The first composite strip is arranged above or below the third strip and then connected to the third strip. In the context of this description, the arrangement “above” or “below” is understood in particular to mean that the strips arranged in this way overlap one another in terms of width and length, and thus the thickness of the two strips which are arranged on top of one another is summed to give a total thickness of the composite.

The connection of the first strip to the second strip to form the first composite strip is advantageous, since it is thus no longer necessary to carefully align the first and the second strip with respect to one another prior to the connection to the third strip. It is then also not possible for any contaminants and/or lubricants to penetrate into a gap between the first and the second strip during or prior to the connection to the third strip. It is also ensured that the first and second strips are not moved relative to one another during the production of the connection to the third strip. Furthermore, a closed strip surface is ensured.

The first composite strip may also be provided in an unwinding apparatus for the connection to the third strip, from which unwinding apparatus the first composite strip is unwound during the production of the connection to the third strip. The connection of the first composite strip to the third strip can be effected similarly to or in the same way as the connection of a strip composed of a single material to the third strip. This is particularly advantageous if the third strip is cladded with the composite strip or vice versa. It is thus possible to use the same cladding apparatus. No adaptations are required.

According to one embodiment of the invention, the connection of the first strip to the second strip may be materially bonded. In particular, it may be a welded connection. A welded connection is particularly stable and is particularly well suited in the case of metals or alloys.

According to one embodiment of the invention, the connection of the first strip to the second strip may be form-fitting.

According to one embodiment of the invention, the first composite strip may be connected to the third strip by cladding. In particular, the connection may be produced by cold roll cladding.

According to one embodiment of the invention, a fourth strip may be produced, in particular from the first material, and is arranged next to the second strip. The first composite strip is then produced by connecting the first strip, second strip and fourth strip in the state when arranged next to one another. The fourth strip may be connected for example to the second strip by way of a welded connection.

According to one embodiment of the invention, a second composite strip may be produced. The third strip may be arranged between the first composite strip and the second composite strip and be connected to the second composite strip. The second composite strip may comprise for example a plurality of strips made of different materials, said strips being connected, in particular welded, to one another. The second composite strip may be connected to the third strip for example by cladding, in particular cold roll cladding.

According to one embodiment of the invention, the second composite strip may be produced in the same way as the first composite strip.

According to one embodiment of the invention, a fifth strip may be produced, in particular from the third material. The first composite strip may be arranged between the third strip and the fifth strip and be connected to the fifth strip. This connection may be effected for example by cladding, in particular cold roll cladding.

According to one embodiment of the invention, the materials may consist in each case of a metal or an alloy.

According to one embodiment of the invention, the first composite strip may comprise a plurality of first strips and at least the second strip arranged next to one another. After the first composite strip has been connected to the third strip, the second strip and the third strip are severed in a direction parallel to a connecting seam between the first and second strips.

In this way, the production of large quantities of the composite material can be simplified. The first composite strip and the third strip may be so wide that the desired width of the composite material is obtained only by way of the severing operation. It is thus possible to produce particularly large quantities of the composite material by means of a few cladding operations.

According to one embodiment of the invention, the first composite strip may comprise a plurality of first strips, second strips and at least the fourth strip arranged next to one another. The fourth strip is wider than the first strips. After the first composite strip has been connected to the third strip, the fourth strip and the third strip are severed in a direction parallel to a connecting seam between the first and second strips. It is also possible for still further strips to be severed in this direction.

In this way, the production of large quantities of the composite material can be simplified. The first composite strip and the third strip may be so wide that the desired width of the composite material is obtained only by way of the severing operation. It is thus possible to produce particularly large quantities of the composite material by means of a few cladding operations.

According to one embodiment of the invention, an apparatus comprises a roll cladding mechanism and a welder and is designed to carry out a method according to an embodiment of the invention. The first composite strip and, if present, the second composite strip may be produced using the welder. This may take place, for example, by welding a plurality of strips to one another, wherein the strips may be composed of different materials. The first composite strip may be connected to the third strip by way of the roll cladding mechanism.

It is of course possible for the roll cladding mechanism to be used to connect the third strip and/or the first composite strip to still further strips and/or composite strips.

### BRIEF DESCRIPTION OF THE DRAWINGS

Further features and advantages of the present invention will become clear from the following description of preferred exemplary embodiments with reference to the accompanying figures. Here, the same reference designations are used for identical or similar components and for components having identical or similar functions. In the figures:

FIG. 1 shows a schematic sectional view of three strips;

FIG. 2 shows a schematic sectional view of a composite material comprising the strips from FIG. 1;

FIG. 3 shows a schematic sectional view of a composite material comprising the strips from FIG. 1;

FIG. 4 shows a schematic sectional view of a composite material comprising three layers of strips;

FIG. 5 shows a schematic sectional view of a composite material comprising three layers of strips;

FIG. 6 shows a schematic sectional view of a composite material which is provided for a subsequent severing operation;

FIG. 7 shows a schematic sectional view of a composite material which is provided for a subsequent severing operation;

FIG. 8 shows a schematic sectional view of a composite material comprising three layers of strips;

FIG. 9 shows a schematic sectional view of a composite material comprising three layers of strips;

FIG. 10 shows a schematic sectional view of a composite material which is provided for a subsequent severing operation;

FIG. 11 shows a schematic sectional view of a composite material which is provided for a subsequent severing operation; and

FIG. 12 shows a schematic sectional view of a first composite strip comprising two strips which are connected to one another in a form-fitting manner.

### DETAILED DESCRIPTION

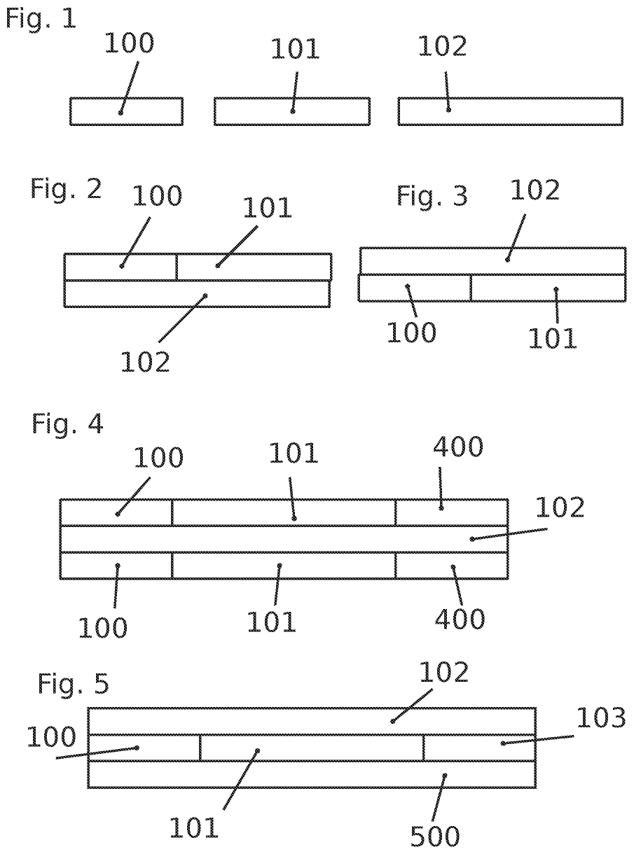

Referring to FIG. 1, a first strip 100 composed of a first metal and a second strip 101 composed of a second metal are welded to one another in their longitudinal direction to form a first composite strip. In this case, the longitudinal direction is the direction in which the strips 100 and 101 have the greatest extent. Subsequently, in the embodiment in FIG. 2, the strips are cladded onto the third strip 102 composed of a third metal. It is also possible for the third strip 102 to be composed of the first or the second metal. Since the width of the third strip 102 corresponds to the sum total of the widths of the first strip 100 and of the second strip 101, the cladding operation can take place in a conventional cladding apparatus. No, or hardly any, specific features have to be observed. In particular, the first strip 100 and the second strip 101 cannot be displaced relative to one another during the cladding operation. It is also ensured that there is no gap between the first strip 100 and the second strip 101 after the cladding operation.

FIG. 3 illustrates that the third strip 102 has been cladded onto the first composite strip. In principle, this can be effected in the same way as in the case of the embodiment from FIG. 2. Similar or identical advantages are likewise produced.

FIG. 4 illustrates the use of a second composite strip and of a fourth strip 400. The fourth strip 400 may be composed for example of the same material as the first strip 100. However, it is also possible for the fourth strip 400 to be composed of another metal or an alloy. In contrast to FIGS. 2 and 3, the first composite strip also comprises the fourth strip 400 in addition to the first strip 100 and the second strip 101. The fourth strip 400 is arranged next to the second strip 101 and is welded to the second strip 101. The second strip 101 is thus arranged between the first strip 100 and the fourth strip 400 and is welded to these two strips.

The second composite strip is formed in the same way as the first composite strip. The third strip 102 in the embodiment from FIG. 4 is wider than the third strip 102 in the embodiments from FIGS. 2 and 3, since its width corresponds to the sum total of the widths of the first and second composite strips.

The third strip 102 is arranged between the first composite strip and the second composite strip. The connections between the third strip 102 and the two composite strips are achieved by way of a cladding operation.

In the embodiment as per FIG. 4, there is also the advantage that, owing to the welds within the composite strips, there are no gaps and a displacement of the strips relative to one another during the cladding operation is impossible or at least made considerably more difficult.

FIG. 5 illustrates a fifth strip 500 which may be composed of the same material as the third strip 102. However, it is also possible for the fifth strip 500 to be composed of another metal or an alloy. In the embodiment as per FIG. 5, the first composite strip is arranged between the third strip 102 and the fifth strip 500. The connections of the first composite strip to the third strip 102 and to the fifth strip 500 are achieved by way of a cladding operation.

In the embodiment as per FIG. 5, there is also the advantage that, owing to the welds within the composite strip, there are no gaps and a displacement of the strips relative to one another during the cladding operation is impossible or at least made considerably more difficult.

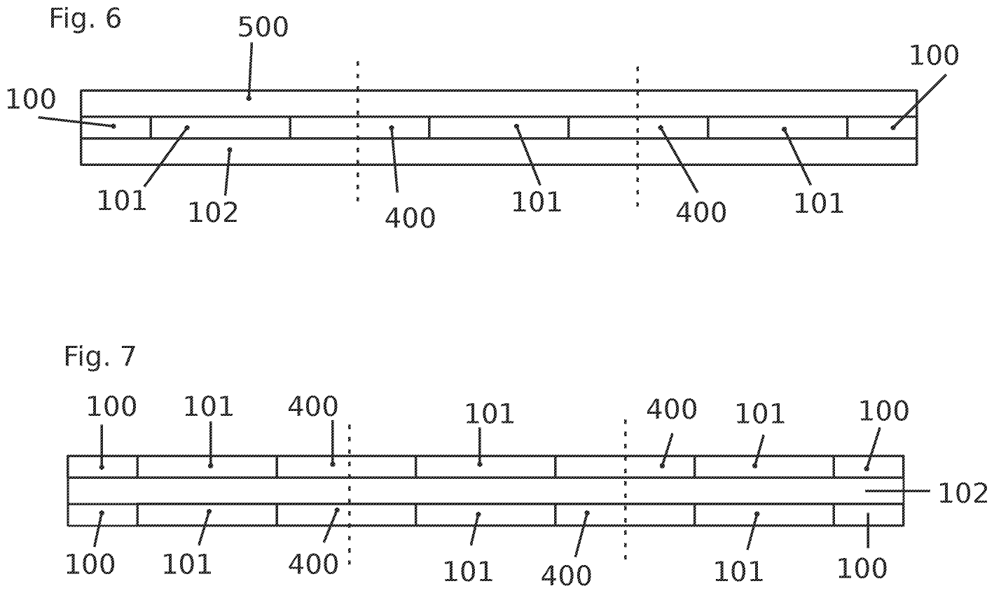

In the embodiment as per FIG. 6, a relatively wide third strip 102 and a relatively wide fifth strip 500 are used. This is associated with the fact that the first composite strip is also very wide, since said first composite strip comprises two first strips 100, three second strips 101 and two fourth strips 400, which are welded to one another. In this case, the fourth strips 400 are twice as wide as the first strips 100.

Also illustrated in FIG. 6 are two dashed lines which serve merely to illustrate lines along which the third strip 102, the fifth strip 500 and the first composite strip are severed in order to produce a plurality of composite materials, as illustrated in FIG. 5. A prerequisite for this is that the fourth strips 400 are twice as wide as the first strips 100 and are composed of the same material as the first strips 100.

With the embodiment from FIG. 6, it is possible to produce a comparatively large number of composite materials with relatively little effort. It is possible to first produce a coil with the embodiment from FIG. 6. The severing operation can subsequently be carried out, such that the number of composite materials is multiplied.

FIG. 7 likewise illustrates an embodiment which can be severed along the lines depicted in dashed fashion, in order to produce a relatively large number of composite materials with relatively little effort. In this case, the procedure is analogous to the procedure described in relation to FIG. 6. The advantages are also similar or identical. From the embodiment as per FIG. 7, it is thus possible to produce a relatively large amount of composite material, as illustrated in FIG. 4, with relatively little effort.

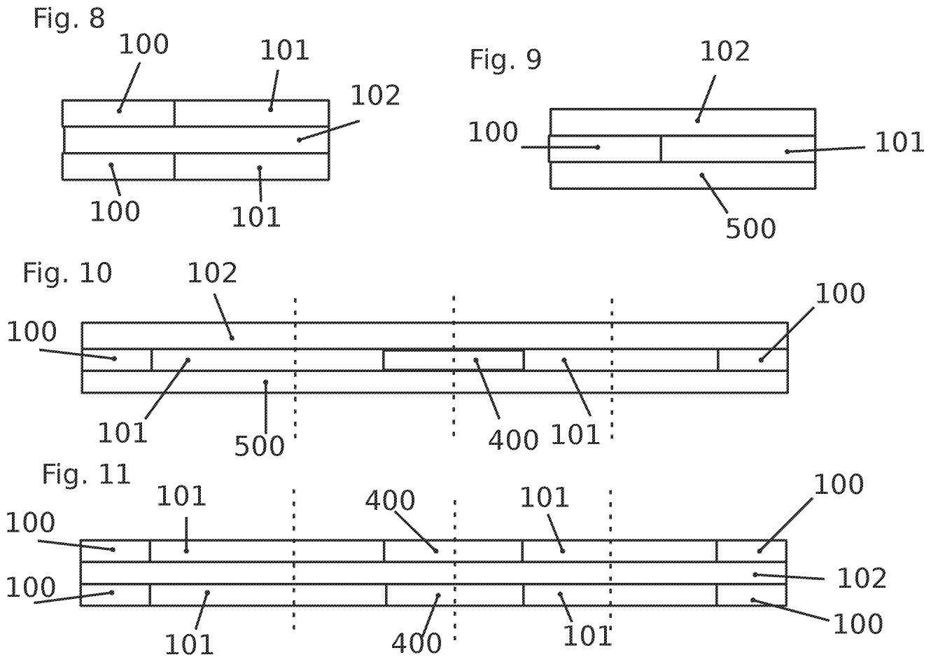

FIG. 8 illustrates a composite material comprising three layers of strips. A third strip 102 is arranged between a first composite strip and a second composite strip. The first composite strip and the second composite strip each comprise a first strip 100 and a strip 101 which is welded to the first strip 100. The embodiment as per FIG. 8 differs from the embodiment from FIG. 4 mainly in that the first and the second composite strip do not comprise a fourth strip.

FIG. 9 illustrates a composite material comprising three layers of strips. A first composite strip comprises a first strip 100 and a strip 101 which is welded to the first strip 100. The first composite strip is arranged between a third strip 102 and a fifth strip 500. The embodiment as per FIG. 9 differs from the embodiment from FIG. 5 mainly in that the first composite strip does not comprise a fourth strip.

The embodiment illustrated in FIG. 10 is similar to the embodiment illustrated in FIG. 6. The first composite strip is composed of first strips 100, second strips 101 and a fourth strip. Here, the fourth strip 400 is twice as wide as the first strips 100 and is composed of the same material as the first strips 100. The dashed lines in FIG. 10 illustrate severing lines along which the third strip, the fifth strip and the first composite strip are severed in order to produce a plurality of composite materials, as illustrated in FIG. 9. It is thus possible to produce a relatively large number of composite materials with relatively little effort.

The embodiment illustrated in FIG. 11 is similar to the embodiment illustrated in FIG. 7. The first and the second composite strip are composed of first strips 100, second strips 101 and a fourth strip 400. Here, the fourth strips 400 are twice as wide as the first strips 100 and are composed of the same material as the first strips 100. The dashed lines in FIG. 11 illustrate severing lines along which the first composite strip, the second composite strip and the third strip 102 are severed in order to produce a plurality of composite materials, as illustrated in FIG. 8. It is thus possible to produce a relatively large number of composite materials with relatively little effort.

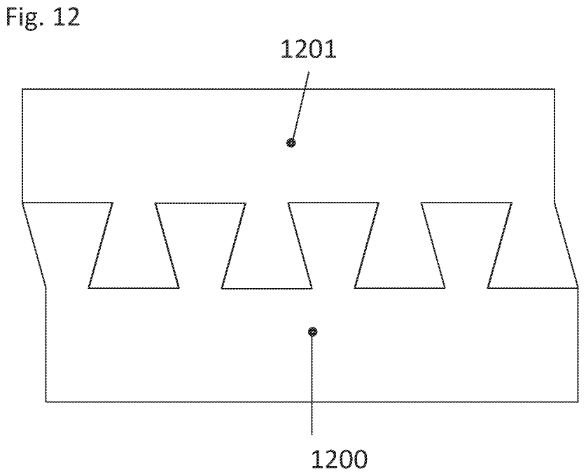

An alternative to the above-mentioned welded connections is illustrated in FIG. 12. It concerns a first composite strip which comprises a first strip 1200 and a second strip 1201. The first strip 1200 is connected to the second strip in a form-fitting manner. The form-fitting connection is achieved by way of an interlocking of the two strips 1200 and 1201 with one another. In principle, this type of connection can be employed wherever two or more strips are connected to one another in a materially bonded manner by for example being welded to one another.

What is claimed is:

1. A method for producing a composite material, the method comprising:
producing a first strip from a first material;
producing a second strip from a second material;
producing a third strip from a third material;
arranging the first and second strips next to one another;
connecting the first strip to the second strip in the state when arranged next to one another to form a first composite strip;
arranging the first composite strip above or below the third strip; and
connecting the first composite strip to the third strip.

2. The method of claim 1, wherein connecting the first strip to the second strip includes materially bonding the first strip to the second strip.

3. The method of claim 1, wherein connecting the first strip to the second strip includes connecting the first and second strips in a form-fitting manner.

4. The method of claim 1, wherein the first composite strip is connected to the third strip by cladding.

5. The method of claim 1, further comprising:
producing a fourth strip from the first material; and
arranging the fourth strip next to the second strip, wherein the first composite strip is produced by connecting the first strip, the second strip, and the fourth strip in a state when arranged next to one another.

6. The method of claim 5, wherein the first composite strip comprises a plurality of first strips, a plurality of second strips, and the fourth strip arranged next to one another, wherein the fourth strip is wider than the first strips, wherein after the first composite strip has been connected to the third strip, the fourth strip and the third strip are severed in a direction parallel to a connecting seam between the first strip and the second strip.

7. The method of claim 6, wherein the fourth strip is halved during the severing.

8. The method of claim 1, further comprising:
producing a second composite strip, wherein the third strip is arranged between the first composite strip and the second composite strip and is connected to the second composite strip.

9. The method of claim 8, wherein the second composite strip is produced in the same way as the first composite strip.

10. The method of claim 1, further comprising:
producing a fourth strip from the third material, wherein the first composite strip is arranged between the third strip and the fourth strip and is connected to the fourth strip.

11. The method of claim 1, wherein each of the first, second, and third materials consists of a metal or an alloy.

12. The method of claim 1, wherein the first composite strip comprises a plurality of first strips and the second strip arranged next to one another, wherein after the first composite strip has been connected to the third strip, the second strip and the third strip are severed in a direction parallel to a connecting seam between the first strips and the second strip.

13. An apparatus, comprising:
a roll cladding mechanism; and
a welder, wherein the apparatus is configured to carry out the method of claim 1, the welder is configured to produce the first composite strip, and the roll cladding mechanism is configured to connect the first composite strip to the third strip.
